(19) United States
(12) Patent Application Publication
(10) Pub. No.: US 2024/0154151 A1
(43) Pub. Date: May 9, 2024

(54) FILAMENT-BASED LITHIUM ADDITIVE DEPOSITION

(71) Applicant: GM GLOBAL TECHNOLOGY OPERATIONS LLC, Detroit, MI (US)

(72) Inventors: Xiaowei YU, Troy, MI (US); Erik Damon Huemiller, Troy, MI (US); Shaomao Xu, Sterling Heights, MI (US); Wayne Cai, Troy, MI (US); Yaoyu Ren, Madison Heihgts, MI (US)

(21) Appl. No.: 17/983,612

(22) Filed: Nov. 9, 2022

(51) Int. Cl. H01M 10/0525; H01M 4/04; H01M 4/134

(52) U.S. Cl. CPC H01M 10/0525; H01M 4/0402; H01M 4/134

(57) ABSTRACT

A lithium addition system includes: a lithium addition head configured to receive a filament of lithium; and a fill control module configured to: identify a defect in a layer of lithium; actuate an actuator and move the lithium addition head to a location of the defect and vertically above the defect; and apply one of power and energy to the filament thereby (a) at least one of softening, melting, and deforming the filament and (b) depositing lithium from the filament into the defect in the layer of lithium.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to lithium electrodes and more particularly to systems and methods of additively depositing lithium metal.

Vehicles with an engine include a battery for starting the engine and supporting accessory loads. Electric vehicles (EVs) such as battery electric vehicles (BEVs), hybrid vehicles, and/or fuel cell vehicles include one or more electric machines and a battery system including one or more battery cells, modules and/or packs to provide propulsion power. A power control system is used to control power to/from the battery system during charging, propulsion and/or regeneration.

Lithium-ion batteries (LIBs) have high power density and are used in EV and non-EV applications. LIBs include anode electrodes, cathode electrodes and separators. The anode electrodes include active material arranged on opposite sides of a current collector. The cathode electrodes include cathode active material arranged on opposite sides of a current collector.

### SUMMARY

In a feature, a lithium addition system includes: a lithium addition head configured to receive a filament of lithium; and a fill control module configured to: identify a defect in a layer of lithium; actuate an actuator and move the lithium addition head to a location of the defect and vertically above the defect; and apply one of power and energy to the filament thereby (a) at least one of softening, melting, and deforming the filament and (b) depositing lithium from the filament into the defect in the layer of lithium.

In further features: the lithium addition head includes at least one electrical heater; and the fill control module is configured to apply power to the at least one electrical heater thereby (a) at least one of softening, melting, and deforming the filament and (b) depositing lithium from the filament into the defect in the layer of lithium.

In further features: the fill control module is configured to apply power to the filament thereby (a) at least one of softening, melting, and deforming the filament and (b) depositing lithium from the filament into the defect in the layer of lithium.

In further features: the lithium addition head includes at least one vibrator; and the fill control module is configured to apply power to the at least one vibrator thereby (a) at least one of softening, melting, and deforming the filament and (b) depositing lithium from the filament into the defect in the layer of lithium.

In further features, the at least one vibrator is configured to vibrate at an ultrasonic frequency when power is applied.

In further features, the fill control module is configured to apply power to a non-consumable electrode of the lithium addition head while the filament is fed into a space between the non-consumable electrode and the defect, the application of power to the non-consumable electrode causing an arc thereby (a) at least one of softening, melting, and deforming the filament and (b) depositing lithium from the filament into the defect in the layer of lithium.

In further features, the fill control module is further configured to flow a shield gas through the lithium addition head and toward the layer of the lithium while applying power to the non-consumable electrode.

In further features, the shield gas is an inert gas.

In further features, a light source is configured to output light onto the filament in a space between the lithium addition head and the defect, the light (a) at least one of softening, melting, and deforming the filament and (b) depositing lithium from the filament into the defect in the layer of lithium.

In further features, the light source is a laser light source.

In further features, the light source is configured to output light having a wavelength between approximately 200 nanometers (nm) and approximately 1200 nm.

In further features, a second lithium addition head is configured to receive a second filament of lithium, where the fill control module is further configured to: identify a second defect in the layer of lithium; actuate a second actuator and move the second lithium addition head to a second location of the second defect and vertically above the second defect; and apply one of power and energy to the second filament thereby (a) at least one of softening, melting, and deforming the second filament and (b) depositing lithium from the second filament into the second defect in the layer of lithium.

In further features, the actuator includes a robot having at least 2 degrees of freedom.

In further features, the actuator is configured to move the lithium addition head linearly perpendicularly to a direction of motion of the layer of lithium through the system.

In further features, at least two of: the lithium addition head includes at least one electrical heater configured to thereby (a) at least one of softening, melting, and deforming the filament and (b) deposit lithium from the filament into the defect in the layer of lithium; the fill control module is configured to apply power to the filament thereby (a) at least one of softening, melting, and deforming the filament and (b) depositing lithium from the filament into the defect in the layer of lithium; the lithium addition head includes at least one vibrator configured to thereby (a) at least one of softening, melting, and deforming the filament and (b) depositing lithium from the filament into the defect in the layer of lithium; the fill control module is configured to apply power to a non-consumable electrode of the lithium addition head while the filament is fed into a space between the non-consumable electrode and the defect, the application of power to the non-consumable electrode causing an arc thereby (a) at least one of softening, melting, and deforming the filament and (b) depositing lithium from the filament into the defect in the layer of lithium; and a light source is configured to output light onto the filament in a space between the lithium addition head and the defect, the light (a) at least one of softening, melting, and deforming the filament and (b) depositing lithium from the filament into the defect in the layer of lithium.

In further features, the lithium layer is disposed on a copper layer of an electrode for a battery.

In further features, the fill control module is configured to retract the filament away from the layer of lithium after the depositing of lithium from the filament into the defect in the lithium layer is complete.

In further features, the fill control module is configured to: determine a volume of the defect; and control feeding of the filament to the lithium addition head based on the volume of the defect.

In further features, a scanning module is configured to scan the surface of the lithium layer, where the fill control module is configured to identify the defect in the layer of lithium based on an output of the scanning module.

In a feature, a lithium addition method includes: identifying a defect in a layer of lithium; actuating an actuator and moving a lithium addition head to a location of the defect and vertically above the defect; and applying one of power and energy to the filament thereby (a) at least one of softening, melting, and deforming the filament and (b) depositing lithium from the filament into the defect in the layer of lithium.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of an example portion of an electrode, such as of a battery;

FIG. 2 is a functional block diagram of an example lithium addition system;

FIGS. 3-8 are perspective views of an example implementation of a lithium addition head; and

FIG. 9 is a functional block diagram of the example lithium addition system of FIG. 1.

In the drawings, reference numbers may be reused to identify similar and/or identical elements.

### DETAILED DESCRIPTION

Electrodes, such as electrodes of batteries, may include layers of lithium with copper or another suitable type of electrical conductor disposed between the layers of lithium. Defects may be present, however, in a lithium layer.

The present application involves filling defects in the lithium layer and filling the defects in the lithium layer additively from a filament of lithium. Energy or electrical power may be applied to the filament to deform or melt or soften the filament for deposition in defects in the lithium layer.

For example, a lithium addition head may be heated or vibrated to melt or soften the lithium of the filament. Additionally or alternatively, arc welding can be used to melt the lithium of the filament. Additionally or alternatively, light can be output to the filament to melt or soften the filament. Additionally or alternatively, power can be applied to the filament to melt or soften the filament.

Filling defects in a lithium layer with lithium from the filament improves performance of resulting electrodes and increases uniformity of thickness of the lithium layer. In various implementations, multiple lithium addition heads can be used concurrently to fill defects and increase throughput of producing electrode material.

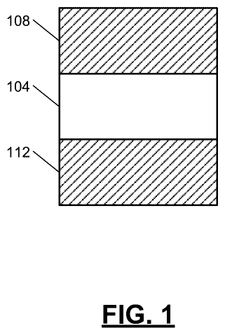

FIG. 1 is cross-sectional view of an example portion of an electrode (e.g., an anode), such as an electrode of a battery of a vehicle. A copper layer 104 is sandwiched between first and second layers of lithium 108 and 112. In the battery, the copper layer 104 may serve as a current collector. While the example of the copper layer 104 is provided, another suitable electrically conductive material may be used, such as copper mesh, copper foil, stainless steel, nickel, and other materials.

Defects may occur in one or more of the lithium layers 108 and 112. For example, a lithium layer may be damaged during manufacturing, during transportation, etc. Defects in a lithium layer may decrease battery performance and may increase scrap rate. The present application involves locally adding/depositing lithium metal in the area of detects using energy and/or heat to fix the defects. This improves battery performance and decreases scrap.

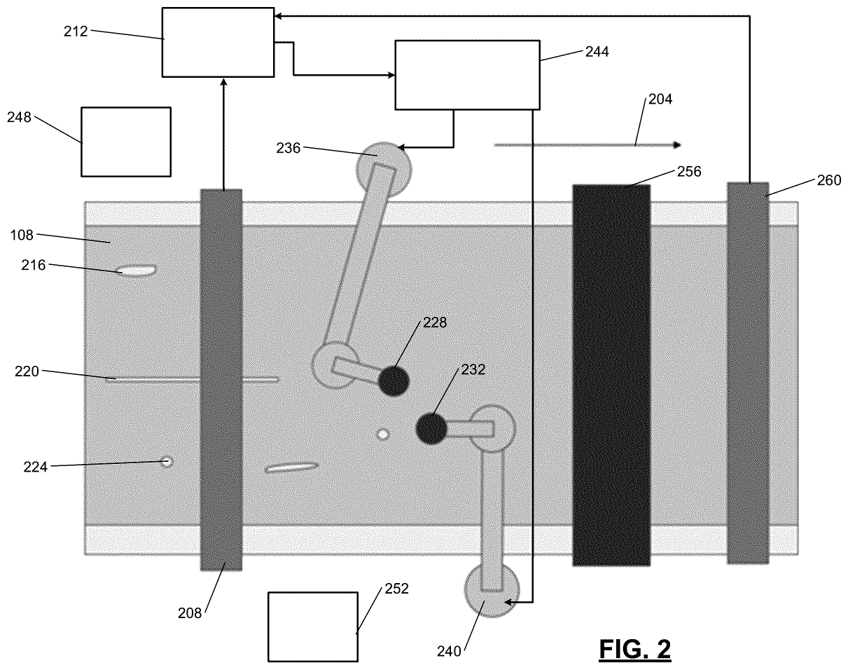

FIG. 2 is a functional block diagram of an example lithium addition system. The example of FIG. 2 is facing the lithium layer 108. While the example of filling defects in the lithium layer 108 will be discussed, defects in the lithium layer 112 may be identified and filled similarly or identically.

The lithium layer 112 is moved through the system in the direction of arrow 204. For example, the electrode material (e.g., including the copper layer 104 and the lithium layers 108 and 112) may be stored on spools and moved through the system from a first spool to a second spool. Defects in the lithium layer are filled using the lithium addition system.

A scanning module 208 scans the surface of the lithium layer 108. The scanning module 208 may scan the surface of the lithium layer 108 using, for example, an X-ray fluorescence, eddy current, one or more lasers, profilometry (e.g., optical or contact), or in another suitable manner. The scanning module 208 may scan the surface of the lithium layer 108 in a direction that is perpendicular to the direction of movement 204 in various implementations.

Based on signals output by the scanning module 208, an inspection module 212 detects locations (e.g., boundaries) and dimensions (e.g., depth, volume) of defects in the lithium layer 108. Examples of defects include divots, like divot 216, scratches, like scratch 220, and holes, like hole 224. The defects include areas that are recessed (e.g., partially or completely through the lithium layer 108) relative to the surface of the lithium layer 108.

The system includes one or more lithium addition heads, such as 228 and 232. While the example of two lithium adder heads is provided, the present application is applicable to one or more lithium addition heads. One or more actuators, such as 236 and 240, move the lithium addition head(s), respectively, to target positions. The actuators may be, for example, robots or another suitable type of actuator. The robot(s) may be, for example, 6 degree of freedom (DoF) or higher robots in various implementations. Defect filling speed and throughput may be increased as the number of actuators and lithium addition heads increases.

A fill control module 244 determines the target location(s) based on the location(s) of defect(s), respectively, in the lithium layer 108. The fill control module 244 may update the target location(s) as the lithium layer 108 moves in the direction 204 based on the amount of movement of the lithium layer 108. The fill control module 244 may determine the amount of movement of the lithium layer 108, for example, by determining a mathematical integral of a speed of the movement of the lithium layer 108 in the direction. The fill control module 244 may set the target location(s) to center(s) of the defect(s) in the lithium layer 108 in various implementations. The fill control module 244 actuates the actuator(s) to move the lithium addition head(s) to the target location(s), respectively. This includes moving the lithium addition head(s) while the lithium layer 108 is moving in the direction 204.

The fill control module 244 determines the amount of lithium to add to each defect based on the dimensions of that defect. For example, the fill control module 244 may determine the amount of lithium using one or more equations and/or lookup tables that relate dimensions of defects to amounts of lithium.

The lithium is provided to the lithium addition head(s) from one or more lithium sources, such as lithium sources 248 and 252. The lithium is stored as a solid lithium filament that is supplied to a lithium addition head. Energy and/or heat at the lithium addition head melts the lithium filament and locally bonds the deposited lithium to the lithium layer 108 within a defect.

The lithium addition system also includes a smoothing roller 256. The smoothing roller flattens and smooths lithium deposited within defects in the lithium layer 108. This increases uniformity of the thickness of the lithium layer 108. In various implementations, the smoothing roller 256 may include a non-stick coating on an outer surface thereof to prevent added lithium from sticking to the smoothing roller 256.

In various implementations, a second scanning module 260 scans the surface of the lithium layer 108 after the electrode material passes through the smoothing roller 256. The second scanning module 260 may scan the surface of the lithium layer 108 using, for example, an X-ray fluorescence, eddy current, one or more lasers, profilometry (e.g., optical or contact), or in another suitable manner. The second scanning module 260 may scan the surface of the lithium layer 108 in a direction that is perpendicular to the direction of movement 204 in various implementations. Based on signals output by the second scanning module 260, the inspection module 212 may determine whether any defects remain in the lithium layer 108. If so, a section of the electrode material including one or more defects in the lithium layer 108 may be discarded, or another round of lithium addition within the defect(s) via one or more lithium addition heads may be performed.

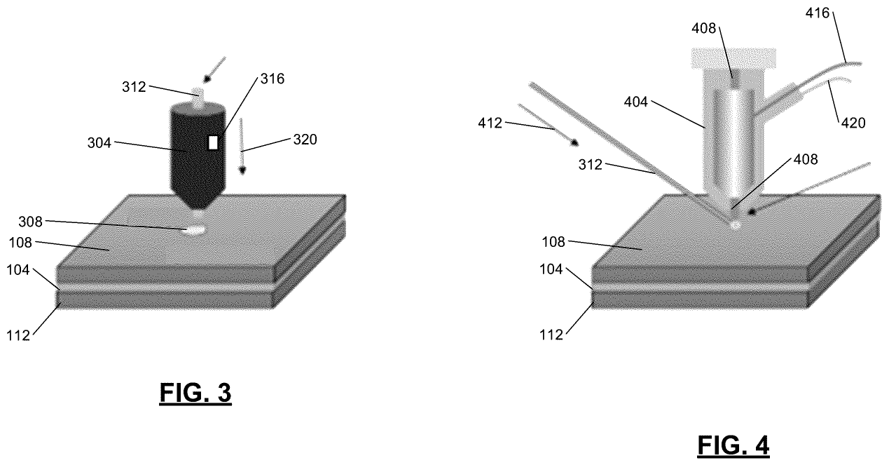

FIG. 3 is a perspective view of an example implementation of a lithium addition head 304. An example defect 308 is shown. As discussed above, the fill control module 244 actuates the actuator and positions the lithium addition head 304 over the defect.

A filament 312 of lithium metal is fed to the lithium addition head 304. The lithium addition head 304 includes one or more heating elements (e.g., resistive heaters) 316 that generate heat when power is applied to the heating element(s). The fill control module 244 controls the feeding of the filament 312 to the lithium addition head 304 and the application of power to the heating element(s). The heating element(s) heat the filament 312 to or to greater than a predetermined (e.g., softening or melting) temperature of the lithium filament 312. This causes the lithium filament 312 to soften, melt, or flow. In the example of molten lithium deposition, a molten lithium reservoir may be included in the lithium addition head 304. In the example of FIG. 3, the filament 312 is fed vertically downwardly toward the lithium layer 108 as illustrated by arrow 320. While only one heating element is shown for simplicity, the lithium addition head 304 may include multiple heating elements.

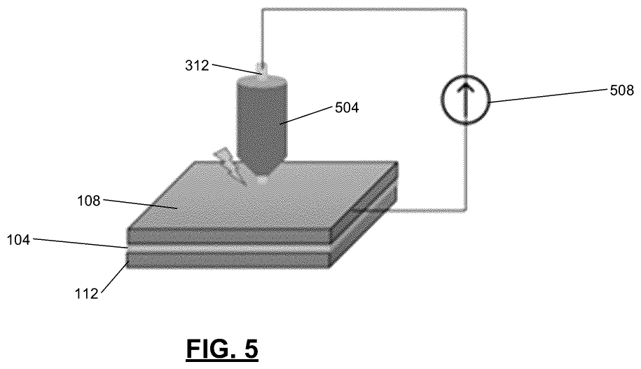

FIG. 4 is a perspective view of an example implementation of a lithium addition head 404. In the example of FIG. 4, the lithium filament 312 is fed to between a non-consumable electrode 408 (e.g., tungsten) of the lithium addition head 404 and the lithium layer 108 at the location of a defect. The filament 312 is fed in the direction illustrated by arrow 412 in FIG. 4.

The fill control module 244 applies power (e.g., a voltage) to the electrode 408 via a power conductor 416. The power applied to the electrode 408 cause an electrical arc between the electrode 408 and the lithium layer 108. The arc melts or flows the lithium filament 312 to fill a defect. A shield gas may be provided to lithium addition head 404 via a gas conduit 420. The lithium addition head 404 may output the shield gas toward the lithium layer 108, for example, to minimize oxide and nitride formation. In the example of FIG. 4, tungsten inert gas (TIG) welding may be performed using the lithium addition head 404 to deposit lithium from the filament 312 into a defect.

FIG. 5 is a perspective view of an example implementation of a lithium addition head 504. In the example of FIG. 5, the lithium filament 312 is fed vertically downward through the lithium addition head 504. The fill control module 244 flows electrical current through the filament 312 or applies voltage to the filament 312 from a current or voltage source 508. Joule heating occurring due to the high resistance between the Li and the substrate generates the power applied to the filament 312, which softens, melts, or flows the lithium filament 312 to fill a defect in the lithium layer 108.

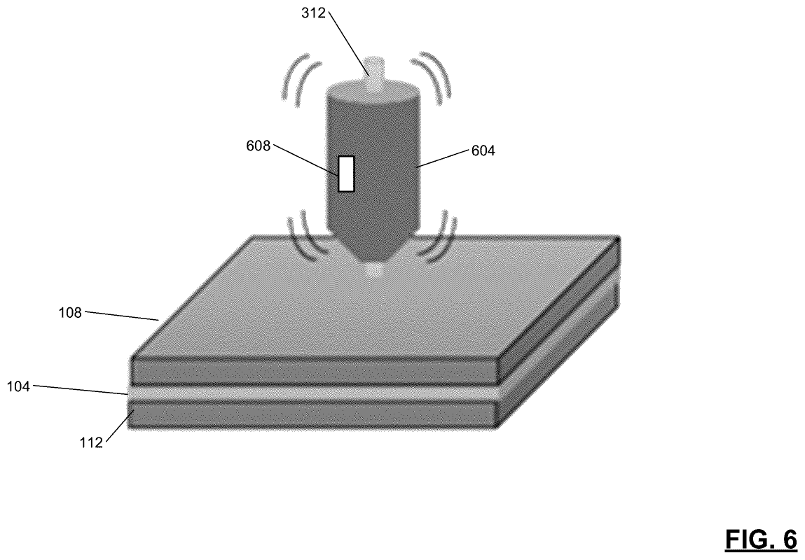

FIG. 6 is a perspective view of an example implementation of a lithium addition head 604. The filament 312 is fed to the lithium addition head 604. The lithium addition head 604 includes one or more vibrators 608 that output energy to the lithium filament 312 and soften or melt the filament 312 when power is applied to the vibrator(s) 608. The fill control module 244 controls the feeding of the filament 312 to the lithium addition head 304 and the application of power to the vibrator(s) 608. The vibrator(s) 608 may vibrate at, for example, an ultrasonic frequency or another suitable frequency. In the example of FIG. 6, the filament 312 is fed vertically downwardly toward the lithium layer 108. While only one vibrator is shown for simplicity, the lithium addition head 304 may include multiple vibrators. In various implementations, the lithium addition head 604 may deposit lithium onto the lithium layer 108 with a plate or roller disposed directly under the electrode material to resist downward force applied by the lithium addition head 604. In various implementations, the plate or roller may include a non-stick coating to prevent sticking between the plate or roller and lithium.

FIG. 7 is a perspective view of an example implementation of a lithium addition head 704. The filament 312 is fed to the lithium addition head 604. The fill control module 244 controls a laser light source 708 to output laser light 712 to the filament 312 between the lithium addition head 704 and the lithium layer 108. The laser light softens or melts the filament 312 for deposition in a defect. The laser light 712 may have a wavelength of between approximately 200 nanometers (nm) and approximately 1200 nm, such as approximately 1064 nm, or another suitable wavelength. Approximately may mean+1-10 percent of stated values. While only one laser light source is shown for simplicity, the multiple light sources may be used. While the example of laser light is provided, the present application is also applicable to other types of light, such as infrared light.

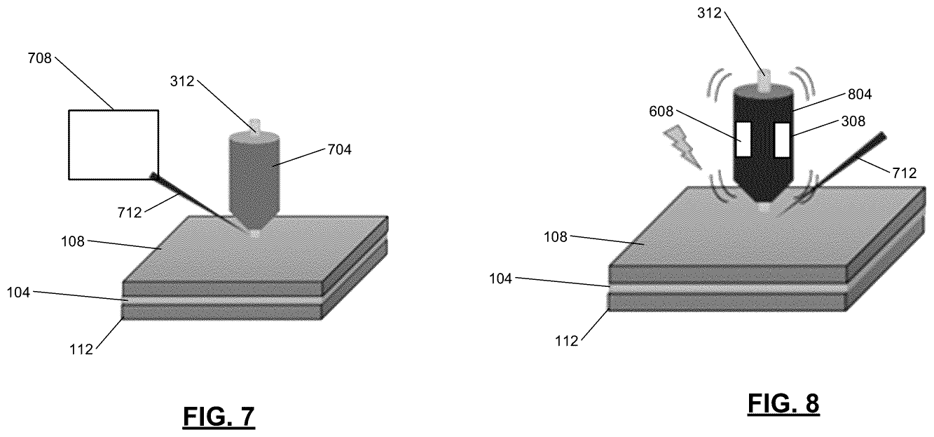

FIG. 8 is a perspective view of an example implementation of a lithium addition head 804. One or more of the above mechanisms of FIGS. 3-7 to soften or melt the lithium filament 312 may be combined and used together. In various implementations, the fill control module 244 may control the filament source to retract the lithium filament 312 after deposition of lithium within a defect is complete. In various implementations, the fill control module 244 may actuate a cutter to between the lithium addition head and the lithium layer 108 after deposition of lithium within a defect is complete. The cutter may cut the lithium filament 312 to allow the lithium addition head to be separated from the lithium layer 108.

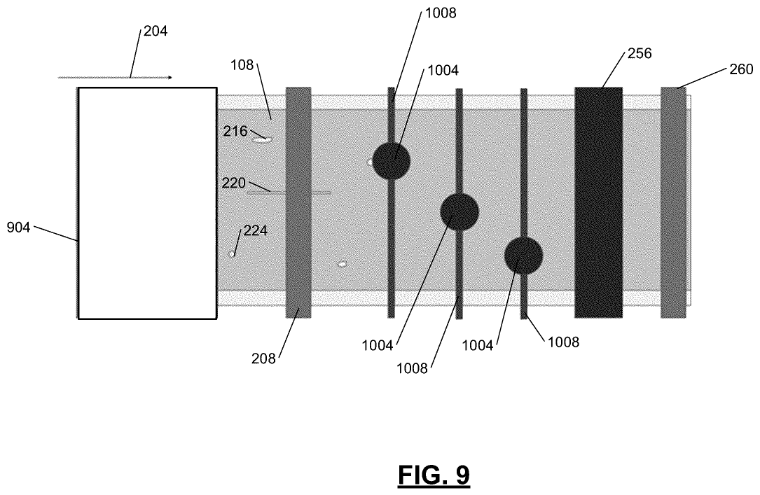

FIG. 9 is a functional block diagram of an example lithium addition system of FIG. 2. In the example of FIG. 9, multiple lithium addition heads 1004 can move along gantries 1008 perpendicularly to the direction of travel 204 of the electrode material. The gantries 1008 may be spaced relative to each other in the direction of travel 204 of the electrode material through the system. In various implementations, lithium from multiple different ones of the lithium addition heads 1004 may be used at different times to fill a single defect (e.g., the scratch 220). The inclusion of multiple independently controllable lithium addition heads may increase throughput and production of defect free electrode material.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A lithium addition system comprising:
a lithium addition head configured to receive a filament of lithium; and
a fill control module configured to:
identify a defect in a layer of lithium;
actuate an actuator and move the lithium addition head to a location of the defect and vertically above the defect; and
apply one of power and energy to the filament thereby (a) at least one of softening, melting, and deforming the filament and (b) depositing lithium from the filament into the defect in the layer of lithium.

2. The system of claim 1 wherein:
the lithium addition head includes at least one electrical heater; and
the fill control module is configured to apply power to the at least one electrical heater thereby (a) at least one of softening, melting, and deforming the filament and (b) depositing lithium from the filament into the defect in the layer of lithium.

3. The system of claim 1 wherein:
the fill control module is configured to apply power to the filament thereby (a) at least one of softening, melting, and deforming the filament and (b) depositing lithium from the filament into the defect in the layer of lithium.

4. The system of claim 1 wherein:
the lithium addition head includes at least one vibrator; and
the fill control module is configured to apply power to the at least one vibrator thereby (a) at least one of softening, melting, and deforming the filament and (b) depositing lithium from the filament into the defect in the layer of lithium.

5. The system of claim 4 wherein the at least one vibrator is configured to vibrate at an ultrasonic frequency when power is applied.

6. The system of claim 1 wherein the fill control module is configured to apply power to a non-consumable electrode of the lithium addition head while the filament is fed into a space between the non-consumable electrode and the defect, the application of power to the non-consumable electrode causing an arc thereby (a) at least one of softening, melting, and deforming the filament and (b) depositing lithium from the filament into the defect in the layer of lithium.

7. The system of claim 6 wherein the fill control module is further configured to flow a shield gas through the lithium addition head and toward the layer of the lithium while applying power to the non-consumable electrode.

8. The system of claim 7 wherein the shield gas is an inert gas.

9. The system of claim 1 further comprising a light source configured to output light onto the filament in a space between the lithium addition head and the defect, the light (a) at least one of softening, melting, and deforming the filament and (b) depositing lithium from the filament into the defect in the layer of lithium.

10. The system of claim 9 wherein the light source is a laser light source.

11. The system of claim 9 wherein the light source is configured to output light having a wavelength between approximately 200 nanometers (nm) and approximately 1200 nm.

12. The system of claim 1 further comprising a second lithium addition head configured to receive a second filament of lithium, wherein the fill control module is further configured to:
identify a second defect in the layer of lithium;
actuate a second actuator and move the second lithium addition head to a second location of the second defect and vertically above the second defect; and
apply one of power and energy to the second filament thereby (a) at least one of softening, melting, and deforming the second filament and (b) depositing lithium from the second filament into the second defect in the layer of lithium.

13. The system of claim 1 wherein the actuator includes a robot having at least 2 degrees of freedom.

14. The system of claim 1 wherein the actuator is configured to move the lithium addition head linearly perpendicularly to a direction of motion of the layer of lithium through the system.

15. The system of claim 1 wherein at least two of:
the lithium addition head includes at least one electrical heater configured to thereby (a) at least one of softening, melting, and deforming the filament and (b) deposit lithium from the filament into the defect in the layer of lithium;
the fill control module is configured to apply power to the filament thereby (a) at least one of softening, melting, and deforming the filament and (b) depositing lithium from the filament into the defect in the layer of lithium;
the lithium addition head includes at least one vibrator configured to thereby (a) at least one of softening, melting, and deforming the filament and (b) depositing lithium from the filament into the defect in the layer of lithium;
the fill control module is configured to apply power to a non-consumable electrode of the lithium addition head while the filament is fed into a space between the non-consumable electrode and the defect, the application of power to the non-consumable electrode causing an arc thereby (a) at least one of softening, melting, and deforming the filament and (b) depositing lithium from the filament into the defect in the layer of lithium; and
a light source is configured to output light onto the filament in a space between the lithium addition head and the defect, the light (a) at least one of softening, melting, and deforming the filament and (b) depositing lithium from the filament into the defect in the layer of lithium.

16. The system of claim 1 wherein the lithium layer is disposed on a copper layer of an electrode for a battery.

17. The system of claim 1 wherein the fill control module is configured to retract the filament away from the layer of lithium after the depositing of lithium from the filament into the defect in the lithium layer is complete.

18. The system of claim 1 wherein the fill control module is configured to:
determine a volume of the defect; and
control feeding of the filament to the lithium addition head based on the volume of the defect.

19. The system of claim 1 further comprising a scanning module configured to scan the surface of the lithium layer,
wherein the fill control module is configured to identify the defect in the layer of lithium based on an output of the scanning module.

20. A lithium addition method comprising:
identifying a defect in a layer of lithium;
actuating an actuator and moving a lithium addition head to a location of the defect and vertically above the defect; and
applying one of power and energy to the filament thereby (a) at least one of softening, melting, and deforming the filament and (b) depositing lithium from the filament into the defect in the layer of lithium.
